(19) United States
(12) Patent Application Publication
(10) Pub. No.: US 2005/0274121 A1
(43) Pub. Date: Dec. 15, 2005

(54) Thermoelectric food product dispenser

(75) Inventors: Shaam Periyapatma Sundhar, Princeton, NJ (US); Damodar Reddy Patlolla, Belmont, CA (US)

Correspondence Address: INSKEEP INTELLECTUAL PROPERTY GROUP, INC, 2281 W. 190TH STREET, SUITE 200, TORRANCE, CA, 90504, US

(73) Assignee: Adventus Consumer Products, LLC

(21) Appl. No.: 11/118,007

(22) Filed: Apr. 29, 2005

Related U.S. Application Data
(60) Provisional application No. 60/566,975, filed on Apr. 30, 2004.

(51) Int. Cl. F25B 21/02; B67D 5/62

(52) U.S. Cl. 62/3.64; 62/389

(57) ABSTRACT

An apparatus for dispensing and storing a food product at a predetermined temperature is provided. This apparatus includes a container for the food product having dispensing means for the dispensing of the food product, a sheath in contact with the container as well as in contact with a thermoelectric chip, a housing having a base portion and an upright portion, the upright portion supporting the sheath above with base portion, a heat sink in contact with the thermoelectric chip and insulating means between the heat sink and the sheath.

### RELATED APPLICATIONS

This invention is related to and claims priority from U.S. provisional application Ser. No. 60/566,975 filed on Apr. 30, 2004 entitled Kool Kween-Tabletop HotiCold Beverage Dispenser, which is incorporated herein by reference.

### BACKGROUND OF THE INVENTION

The present invention relates generally to an apparatus for storing and dispensing of food product at a predetermined temperature, and more particularly to one which utilizes a thermoelectric chip.

In the restaurant/food service industry, heated beverages are often dispensed to which it may be desirable to add milk or cream. Examples of these types of beverages include hot tea, coffee and hot chocolate. Most current dispensers of milk or cream for consumption with those hot beverages utilize ice. However, since the devices are not self-cooling, the ice must be constantly repacked. The cost of the ice as well as the cost of labor associated with the repacking decreases the desirability of using ice cooled units. Until now the only alternative has been the use of a freon cooled unit. However, the alternative has been found to not be desirable due to the size associated with freon cooled units, which also utilize a compressor. Furthermore, the cost associated with such units due to the mechanical parts, as well as repair costs due to the mechanical parts, in addition to the environmental concerns being raised with respect to the effect of freon on the ozone layer.

Thermoelectric refrigerating appliances are known to exist. Examples of such refrigerating units include Mueller, U.S. Pat. No. 3,220,198; Mueller, U.S. Pat. No. 3,324,667; Beitner, U.S. Pat. No. 4,107,924; Beitner, U.S. Pat. No. 4,383,414; Sudmeier, U.S. Pat. No. 3,194,023; and Sarbacher, U.S. Pat. No. 3,664,144. All of the above, with the exception of Sarbacher, disclose actual refrigeration units, whose sole purpose is to store food products. Sarbacher discloses a self-powered refrigerated disposable container which makes use of a thermoelectric cooling device which is placed within a cavity of a container, to cool the contents thereof. Thus, none of the above patents disclose the utilization of thermoelectric technology with a dispenser capable of providing individualized portions of a food product, while at the same time being capable of storing the as yet unused portion.

It is thus apparent that the need exists for an improved apparatus for storing and dispensing a food product at a predetermined temperature which provides individualized portions as well as permitting the safe storage of the as of yet unused food product.

### SUMMARY OF THE INVENTION

There is disclosed an apparatus for dispensing a food product at a predetermined temperature, the apparatus comprising a container for the food product, the container having dispensing means for the dispensing of the food product, a sheath and contact with the container, the sheath also in contact with a heat conductive block, the block also in contact with a thermoelectric chip, a housing having a base portion and an upright portion, the upright portion supporting the sheath above the base portion, a heat sink in contact with the thermoelectric chip, and insulating means located between the heat sink and the sheath.

There is also disclosed an apparatus for storing and dispensing a food product at a predetermined temperature, the apparatus comprising a container for the food product, the container having dispensing means for the dispensing of the food product, the Dispensing means including a spout attached to the container and including a pivotable arm means, a sheath surrounding and in direct contact with the container, the sheath also in direct contact with a heat conductive block, the block also in contact with a thermoelectric chip, a housing having a base portion and an upright portion, the upright portion supporting the sheath above the base portion, a heat sink in contact with the thermoelectric chip, the sheath secured to the heat sink by fastening means, the fastening means passing through the insulating means, and insulating means located between the heat sink and the sheath.

There is also disclosed an apparatus for dispensing a food product at a predetermined temperature, the apparatus comprising a container for the food product, the container having a dispensing means for the dispensing of the food product, a sheath in contact with the container and in contact with a thermoelectric chip, a housing having a base portion and an upright portion, the upright portion supporting the sheath above the base portion, a heat sink in contact with the thermoelectric chip, and insulating means located between the heat sink and the sheath.

The apparatus may also contain a thermostat which regulates the temperature associated with the thermoelectric chip. Furthermore, the apparatus may have a thermoelectric chip capable of having its polarity reversed, such that the apparatus may be used to both cool as well as heat a food product. Additionally, the sheath and container may be surrounded by an insulative cover.

It is a primary object of the present invention to provide an apparatus for dispensing a food product at a predetermined temperature which provides individualized portions of the food product while at the same time providing for the storage of the as of yet unused food product.

Yet another important object of this invention is to provide a thermoelectric apparatus for dispensing a food product which is relatively inexpensive to fabricate as well as being a relatively compact size.

Still yet another important object of the present invention is to provide an apparatus for dispensing a food product at a predetermined temperature, which can be utilized to dispense both cool or chilled, as well as hot food product.

Other objects and advantages of the invention will be apparent from the following description, the accompanying drawings and the appended claims.

### BRIEF DESCRIPTION OF THE DRAWINGS

FIG. 1 is a perspective view of the apparatus for dispensing a food product in accordance with the present invention.

FIG. 2 is a top plan view of the apparatus shown in FIG. 1.

FIG. 3 is a vertical sectional view on an enlarged scale taken along line 3-3 of FIG. 2.

FIG. 4 is a horizontal sectional view taken along line 4-4 of FIG. 3.

FIG. 5 is a horizontal sectional view similar to the spout portion of the invention shown in FIG. 3 but of a modified embodiment.

FIG. 6 is a perspective view of yet another modified embodiment of the invention.

### DETAILED DESCRIPTION OF THE INVENTION

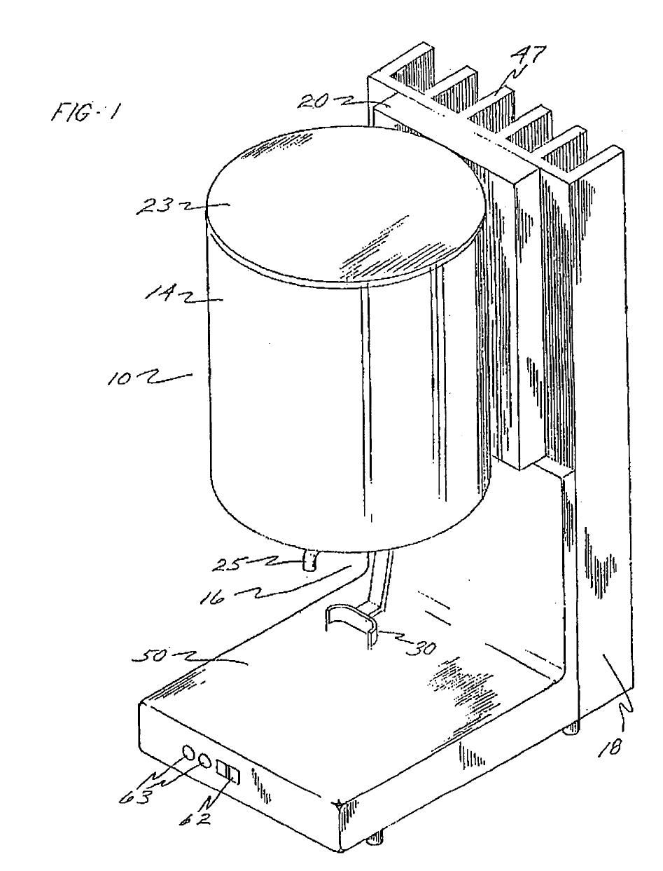

Having reference to the drawings, attention is directed first to FIG. 1 which illustrates an apparatus for dispensing a food product at a predetermined temperature embodying this invention designated generally by the numeral 10. The primary components of the invention are a container 12, sheath 14, housing 16, heat sink 18, and insulating means 20. The plastic insulating means 20 is approximately 2″-2-1.2″ thick, so as to provide sufficient insulation to the sheath from the opposite temperature associated with heat sink 18.

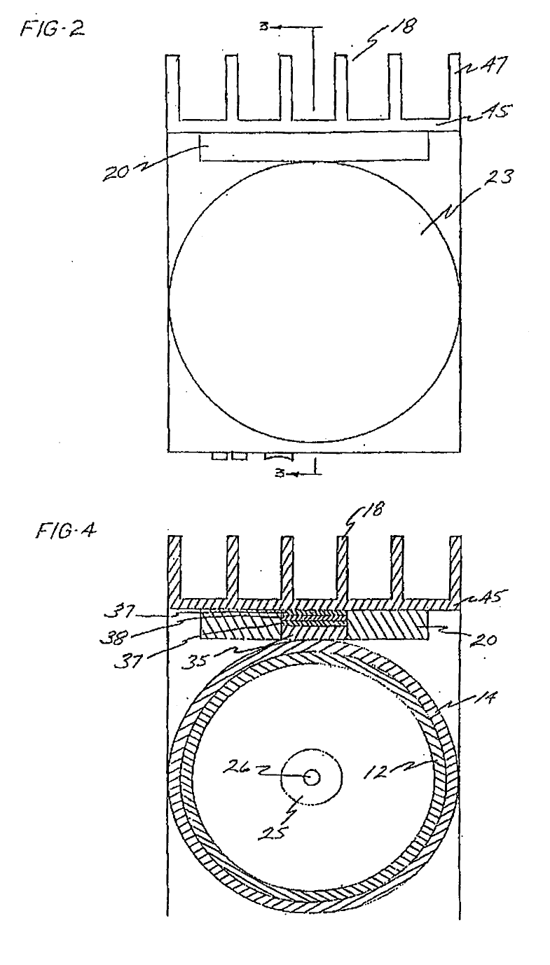

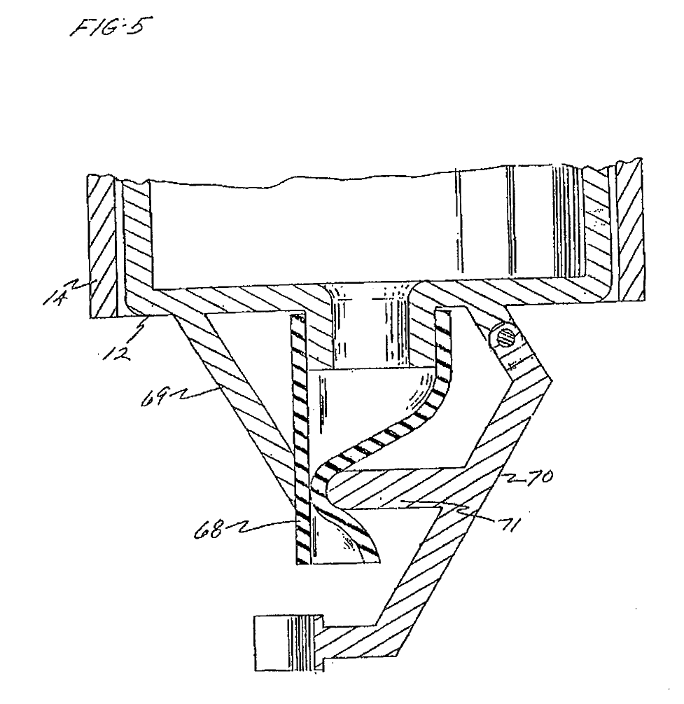

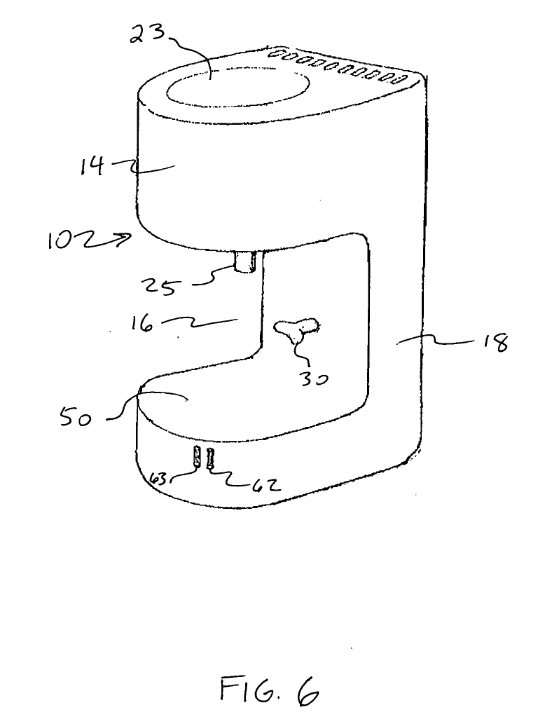

As can be seen in FIGS. 2, 3, and 4, container 12 has a top portion 22 which rests against the inner wall of sheath 14. Additionally, lid 23 rests on the top edge of sheath 14 and container 12 to effectively preclude the food product from atmospheric exposure. Preferably container 12 is fabricated from a thermal conducting plastic or metal while sheath 14 is preferably fabricated from a thermal conducting metal such as aluminum.

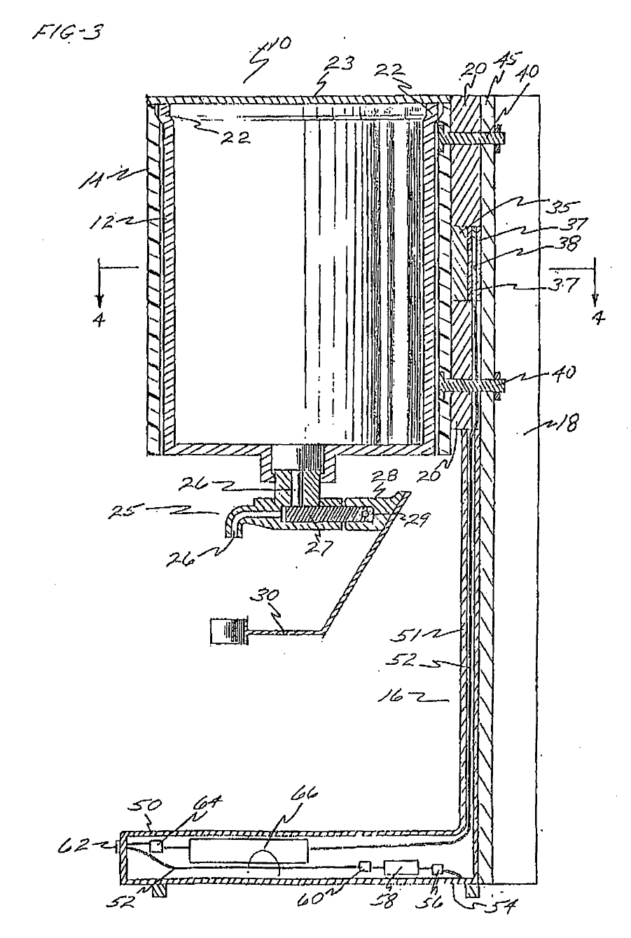

At the lower most portion of container 12 depends on a spout dispenser 25 which may be of a conventional design similar to that shown in FIG. 3, including channel 26, plunger 27 and rocker member 28. Rocker member 28 pivots about pin 29 as arm 30 is depressed by for example a coffee cup. The rearward pressure exerted upon arm 30 causes rocker member to pivot about pivot point 29 so as to withdraw the plunger which preferably is maintained through a conventional spring means not shown, so as to open channel 26 from the interior of the container to the exterior opening of spout dispenser 25.

At the rear of sheath 14, sheath 14 is in direct contact with heat conductive block 35, which preferably also is of aluminum. The heat conductive block is secured by adhesive layer 37 to a thermoelectric chip 38 which is in turn secured by another adhesive layer 37 to heat sink 18.

The thermoelectric chip is typical of those already in existence, being a ceramic wafer with positive and negative legs of bismuth teleuride. The positive leg of the chip is doped with boron while the negative leg is doped with arsenic such that its constituency is 99% bismuth teleuride and 1% arsenic.

Fastening means 40 secure sheath 14 to front wall 45 of heat sink 18. Additionally, fastening means 40 pass through insulating means 20 while preferably being fabricated from a plastic, surrounds heat conductive block 35 either totally or at least substantially such that insulating means 20 resembles a rectangular of oblate shape with a hole at its middle, which hole accommodates the heat conductive block 35.

Heat sink 18 in addition to having a front wall 35 also has a plurality of rearwardly projecting fins 47. Preferably heat sink 18 is also fabricated from aluminum so as to effectively give off heat.

Housing 16 is comprised of a base portion 50 and an upright portion 51 with the upright portion supporting the sheath above the base portion. Housing 16 is preferably hollow to facilitate the passing of wiring 52 therethrough as well as providing space to accommodate several electronic devices. The apparatus 10 is powered by a conventional AC power source 54 with the wiring therefrom passing through a fuse 56, transformer 58 which converts either 220 or 110V to 15V. The current then passes through a bridge rectifier 60 which converts the alternating current to direct current, with this conversion being associated with a slight current drop to approximately 12V.

The housing preferably also includes a three-way toggle switch 62 which provides or the “off” position as well as a cooling and a heating position. Depending upon whether the toggle is turned to the cool or heat mode, the polarity of the chip is affected such that when the polarity of the chip is reversed, the sheath experiences a reversal in terms of the heat given off or absorbed. To assist in identifying which mode the invention is in, a pair of indicator lights 63 can be connected by conventional means to the toggle to facilitate this notification.

A capacitor 64 is included in the invention to serve as a filter to smooth out the current flow since thermoelectric chips typically need less than a 5% ripple effect for efficient operation thereof. Thermostat 66 is provided to adjust the temperature by controlling the current flow into thermoelectric chip 38. At 12V, the normal wattage is 48 watts. As the amplitude is lowered, a lower resulting temperature emerges as a result of the activity of the thermoelectric chip 38. A device which consumes approximately 48 watts per day, translates into a cost of electricity of approximately seven cents per day.

In a modified embodiment of the invention, a modified spout 68 is provided, similar to those often found in multi-gallon milk dispensing machines. A shut-off plate 69 is positioned in front of the modified flexible plastic spout 68 such that a modified arm 70 in its rest position has projection 71 abutting against one side of the spout so as to occlude the passage of food product therethrough. As with the preferred embodiment of the invention, the rearward depression of arm 70 releases the pressure applied by projection 71 upon modified spout 68 such that the food product will flow downwardly from container 12 through spout 68.

Another modification to the embodiment is shown in FIG. 6 wherein an insulative cover 75 may be placed around container 12 and sheath 14 to provide additional insulation. This insulative cover may be a polyurethane foam with a thickness of approximately 1″-1½″.

The form of apparatus herein described constitutes a preferred embodiment of this invention, it is to be understood that the invention is not limited to this precise form of apparatus, and that changes may be made therein without departing from the scope of the invention which is defined in the appended claims.

1. A beverage dispenser comprising:
a container;
a tap in fluid communication with said container and operable to controllably dispense liquid from the container;
a heat sink;
a thermoelectric chip disposed between said container and said heat sink such that, when electricity is supplied to said thermoelectric chip, said thermoelectric chip transfers heat from said container to said heat sink.

2. The beverage dispenser of claim 1 further comprising a thermo-conductive sheath surrounding said container.

3. The beverage dispenser of claim 1 further comprising a thermostat electrically connected to said thermoelectric chip.

4. The beverage dispenser of claim 1 further comprising a housing having a base portion and an upright portion, said upright portion supporting said container above said base portion.

5. The beverage dispenser of claim 4 wherein said heat sink is disposed on a back of said housing.

6. The beverage dispenser of claim 5 wherein said heat sink comprises rearwardly-projecting fins.

7. The beverage dispenser of claim 6 wherein said rearwardly-projecting fins are vertically oriented.

8. The beverage dispenser of claim 2 wherein said container is removably disposed within said sheath.

9. The beverage dispenser of claim 1 further comprising insulation disposed between said heat sink and said container.

10. A method of storing and providing a chilled beverage to a consumer without refrigerant comprising:
filling a container with said beverage;
removing heat from said beverage to a heat sink using a thermoelectric chip supplied with electricity;
passing the fluid through a dispensing mechanism when said dispensing mechanism is operated by the consumer.

11. The method of claim 10 wherein removing heat from said beverage to a heat sink comprises monitoring an actual temperature of said beverage and removing heat from said beverage as necessary to maintain the actual temperature of said beverage within a desired temperature range.

12. The method of claim 10 wherein removing heat as necessary to maintain the actual temperature of said beverage within a desired temperature range comprises periodically removing heat from the beverage.

13. A device for storing, dispensing, and maintaining a consumable at a desired temperature comprising:
a removable storage container;
a thermo-conductive sheath surrounding said storage container;
a thermoelectric chip operably connected to said sheath for transferring heat to and from said sheath when electricity is supplied to said thermoelectric chip;
a heat sink operably connected to said thermoelectric chip for receiving and dissipating heat transferred thereto by said thermoelectric chip.

14. The device of claim 13 further including a switch, operably connected to said thermoelectric chip, operably to reverse a polarity of electricity supplied to said chip, whereby a first polarity causes said thermoelectric chip to transfer heat from said sheath to said heat sink and a second polarity causes said thermoelectric chip to transfer heat from said heat sink to said sheath.

15. The device of claim 13 further comprising a conduit in a bottom of said container usable to drain fluid from said container.

16. The device of claim 15 further comprising a dispensing mechanism connected to said conduit for controlling fluid flow through said conduit.

17. The device of claim 13 further comprising a thermostat connected to said thermoelectric chip.

18. The device of claim 13 further comprising a housing having a base portion and an upright portion, said upright portion supporting said container above said base portion.

19. The device of claim 18 wherein said heat sink is disposed on a back of said housing.

20. The device of claim 19 wherein said heat sink comprises rearwardly-projecting fins.
